(19) United States
(12) Patent Application Publication
(10) Pub. No.: US 2006/0221247 A1
(43) Pub. Date: Oct. 5, 2006

(54) Vertical scanning television

(76) Inventors: Didier Doyen, La Bouexiere (FR); Laurent Blonde, Thorigne Fouillard (FR); Luis Montalvo, Domloup (FR)

Correspondence Address: THOMSON LICENSING INC., PATENT OPERATIONS, PO BOX 5312, PRINCETON, NJ, 08543-5312, US

(21) Appl. No.: 11/389,944

(22) Filed: Mar. 27, 2006

(30) Foreign Application Priority Data
Mar. 31, 2005 (FR) 05/50825

(51) Int. Cl. H04N 9/74

(52) U.S. Cl. 348/583

(57) ABSTRACT

The present invention relates to a television comprising means for receiving line by line a video input image, a circuit for processing said video input image able to apply at least one horizontal video processing and one vertical video processing to pixels of the video input image and means of vertical scanning for displaying the video image coming from the processing circuit column of pixels by column of pixels. The invention aims to reduce the number of memory of lines that are necessary for performing the vertical video processings. According to the invention, the vertical video processings are performed after an image rotation so as to perform them as horizontal video processings, that is to say without having to use line memories. Application to cathode-ray televisions.

### FIELD OF THE INVENTION

The present invention relates to a television comprising means for receiving a video input image, a circuit for processing said video input image able to apply at least one video processing to pixels of the video input image belonging to one and the same column of pixels, called vertical video processing, and means of vertical scanning for displaying, column of pixels by column of pixels, the video image coming from the processing circuit. The invention is more particularly applicable to cathode-ray tube televisions.

### BACKGROUND OF THE INVENTION

In the design of current cathode-ray tube televisions, the scanning of the tube is performed line by line horizontally in synchronization with the incoming video signal. All the lines of the tube are scanned sequentially with, as a general rule, interlacing of the lines originating from two successive video frames of the incoming video signal.

This scanning system is still today the system encountered in all cathode-ray tube televisions. On account of the competition that is emerging with other screen technologies, in particular liquid crystal screens, plasma screens and backprojectors, cathode-ray tube screens are having to evolve towards thinner products in order to hope to remain dominant in the market for as long as possible. Reducing the depth of a tube involves having a greater angle of deflection for the electron beam. This results in:
worse image quality since it will be more difficult to adjust the geometry and the convergence of the tube, and
extra cost and increased consumption at the tube deflector level since the-electron beam will have to be deflected even more.

An interesting technical solution for reducing the depth of the tube is to scan this tube in the vertical direction, that is to say from bottom to top for the signal having the highest frequency, rather than, as now, in the horizontal direction. An immediate advantage is that the angle of deflection for the signal having the highest frequency is much smaller. It is reduced by a factor of 16/9 when the ratio of the width to the height of the screen is 16/9. This subsequently results in lower consumption and a decrease in the size of the luminous spot.

The implementation of this principle in a conventional television requires the addition of a function for rotating the video information before display thereof by the tube. Specifically, the video information arrives line by line in the television and must be rearranged column by column so as to be displayed by means of a vertical scan. In the subsequent description, a “line” denotes a horizontal line and a “column” denotes a vertical line. This rotation function requires an image memory for storing the video information of a whole image. This memory is already present in certain current televisions for converting the 50 Hz video signal into a 100 Hz signal.

The video rotation function may be integrated without major difficulty into a current television. However, it is possible to optimize the position of the rotation function so as to reduce the resources required for the video processing and thus reduce the cost of the integration of such a function into a conventional television.

### SUMMARY OF THE INVENTION

The present invention relates to a television comprising means for receiving a video input image comprising a matrix of pixels organized in lines and columns, said video input image being received line of pixels by line of pixels, a circuit for processing said video input image able to apply at least one video processing to pixels of the video input image belonging to one and the same column of pixels, called vertical video processing, and means of vertical scanning for displaying, column of pixels by column of pixels, the video image coming from the processing circuit.

According to the invention, the processing circuit comprises:
an image rotation circuit intended to pivot the video input image by 90° so as to transform the columns of pixels of the video input image into lines of pixels, and
a block, called vertical block, for applying said vertical video processing by acting on the lines of pixels of the pivoted video image, the processed image coming from the vertical block being displayed by the means of vertical scanning.

If a video processing on pixels of the input video image belonging to one and the same line of pixels, called horizontal video processing, is to be performed, the processing circuit then comprises a block, called horizontal block, for applying this horizontal processing and this horizontal block is placed upstream of the rotation circuit.

This layout of the processing blocks with respect to the image rotation circuit makes it possible in particular to dispense with line memory for the application of the vertical processing.

### BRIEF DESCRIPTION OF THE DRAWINGS

The invention will be better understood on reading the following description, given by way of non-limiting example, and with reference to the appended drawings in which:

FIG. 1 diagrammatically represents the layout of the blocks necessary for the video processing in a conventional vertical scanning television;

FIG. 2 represents the means necessary for carrying out a vertical filtering operation; and

FIG. 3 represents the novel layout of the blocks necessary for the video processing in a vertical scanning television.

### DETAILED DESCRIPTION OF PREFERRED EMBODIMENTS

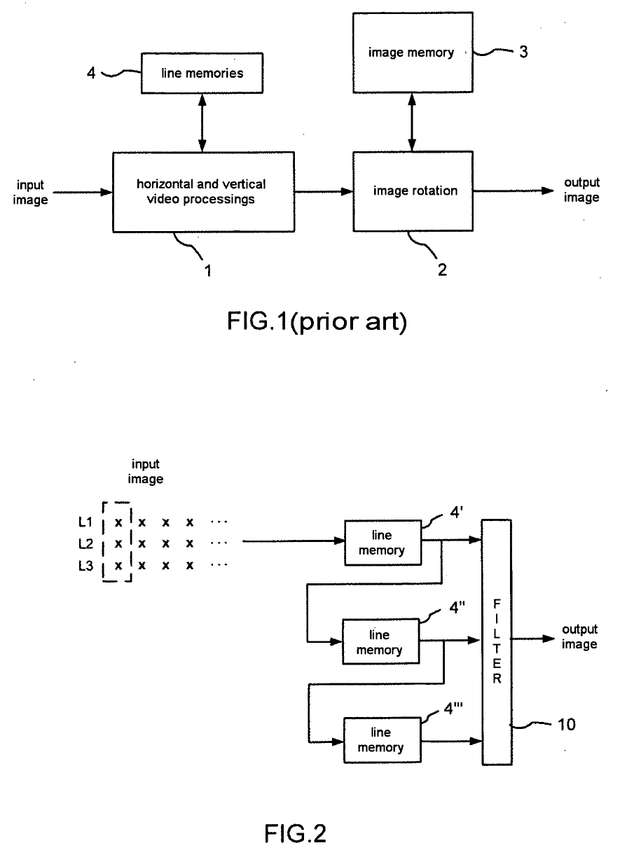

FIG. 1 shows the layout of the blocks necessary for the video processing in a conventional vertical scanning television. The input image is processed by a horizontal and vertical video processings block 1. The information of the input image is provided line by line to the block 1. This block 1 is hooked up to line memories 4 to be able to carry out the vertical video processings. An exemplary vertical processing is described later with reference to FIG. 2. After the horizontal and vertical video processings, the image is pivoted by 90° by means of an image rotation circuit 2. This block is hooked up to an image memory 3 which can for example be the memory used to convert the 50 Hz video signal into a 100 Hz signal. The rotation of the image consists in sequentially storing the lines of pixels of the processed image coming from the block 1 then subsequently in reading the image stored columns of pixels by column of pixels.

FIG. 2 illustrates, by way of example, an operation of vertical filtering of the input image. This operation consists in applying a filtering to an image pixel belonging to a line L2 using the pixels of two other lines L1 and L3. For this processing, three line memories 4′, 4′ and 4″′ are necessary for storing respectively the lines L1, L2 and L3. The three pixels are thereafter provided to a filter 10 charged with applying the vertical filtering.

The invention makes it possible to dispense with the line memories 4 necessary for the vertical video processing. This aim is achieved by modifying the position of the image rotation circuit with respect to the video processing block of the television. According to the invention, the position of the image rotation circuit is determined so that the following rule applies: all the horizontal video processings are to be performed before the image rotation and all the vertical video processings are to be performed after the image rotation. Thus, the vertical video processings may be processed as horizontal video processings and the whole collection of video processings, be they horizontal or vertical, may be done without using any line memory.

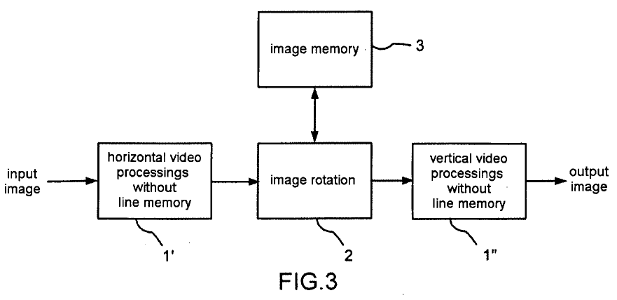

For this purpose, the vertical and horizontal video processings block 1 is split into a block for horizontal video processings 1′ and a block for vertical video processings 1″ and the image rotation circuit 2 is inserted between the two blocks 1′ and 1″ as illustrated by FIG. 3. The block 1″ being positioned downstream of the image rotation circuit 2, the vertical video processings henceforth require only the storage of a few pixels like the horizontal video processings.

The various video processings are therefore grouped into three groups:
a first group comprising the horizontal video processings which are implemented in the block 1′; this group comprises for example the horizontal filtering for controlling format for performing the conversion from the 4/3 format to the 16/9 format in the horizontal direction or the horizontal peaking.
a second group comprising the horizontal video processings which are implemented in the block 1″ ; this group comprises for example the vertical filtering for controlling format for performing the conversion from the 4/3 format to the 16/9 format in the vertical direction or the vertical chrominance interpolation.
a third group which groups together the processings which are performed at the current pixel level without involving neighbouring pixels; these processings may be carried out either before or after the image rotation.

By dispensing with the line memories 4 one obtains a not insignificant gain in terms of area in the integrated circuit dedicated to the video processing.

1. Television comprising means for receiving a video input image comprising a matrix of pixels organized in lines and columns, said video input image being received line of pixels by line of pixels, a circuit for processing said video input image able to apply at least one video processing to pixels of the video input image belonging to one and the same column of pixels, called vertical video processing, and means of vertical scanning for displaying, column of pixels by column of pixels, the video image coming from the processing circuit,
wherein the processing circuit comprises:
an image rotation circuit intended to pivot the video input image by 90° so as to transform the columns of pixels of the video input image into lines of pixels, and
a block, called vertical block, for applying said vertical video processing by acting on the lines of pixels of the pivoted video image, the processed image coming from the vertical block being displayed by the means of vertical scanning.

2. Television according to claim 1, wherein the processing circuit furthermore comprises a block, called horizontal block, for applying at least one video processing, called horizontal video processing, to pixels of the video input image belonging to one and the same line of pixels and in that said horizontal block is placed upstream of the rotation circuit.

3. Television according to claim 1, wherein said image rotation circuit comprises a memory able to store the video input image or the video image processed by the horizontal block and means for controlling the memory write and read operations in such a way as to produce said pivoted image.

4. Television according to claim 2, wherein said image rotation circuit comprises a memory able to store the video input image or the video image processed by the horizontal block and means for controlling the memory write and read operations in such a way as to produce said pivoted image.
